(19) United States
(12) Patent Application Publication
(10) Pub. No.: US 2008/0200057 A1
(43) Pub. Date: Aug. 21, 2008

(54) Half length SIM card reader with cover and hinge

(76) Inventors: Geng Yu Ming, Haidian District (CN); Yang Shi Qing, Haidian District (CN); Zhang Yi Bin, Haidian District (CN)

Correspondence Address: HAVERSTOCK & OWENS LLP, 162 N WOLFE ROAD, SUNNYVALE, CA, 94086, US

(21) Appl. No.: 11/708,869

(22) Filed: Feb. 20, 2007

(51) Int. Cl. H01R 13/62

(52) U.S. Cl. 439/326

(57) ABSTRACT

The present invention is a half length SIM card reader with a cover and a hinge. By using the half length SIM card reader, the restriction area on the printed circuit board is very small. The restriction area is about half the size of a SIM card, unlike other SIM card readers which require space longer than the SIM card. By having a small footprint, additional components are able to be included on the printed circuit board. Furthermore, the assembled cover with the hinge provides vertical operation of the SIM card.

### FIELD OF THE INVENTION

The present invention relates to the field of computing. More specifically, the present invention relates to Subscriber Identity Module (SIM) card readers.

### BACKGROUND OF THE INVENTION

A SIM card is a smart card that securely stores a key identifying a mobile phone service subscriber, as well as subscription information, saved telephone numbers, preferences, text messages and other information.

A SIM card reader is a device that allows the contents of a SIM card to be read and edited. SIM card readers come in a variety of configurations such as a full length cover with a hinge or a reader with a bridge and stopper. The full length cover is the full length of the SIM card which results in the restriction area on a printed circuit board to be slightly larger than the SIM card. Since the SIM card reader has a footprint slightly larger than the SIM card, it is impossible to place any small components or test points on the printed circuit board under the SIM card. The SIM card reader with a bridge and stopper has many benefits such as a small footprint itself, but it requires additional operational space.

SIM card readers are a critical component in mobile phone design. The restriction area and operation space are key features that have important influence on the design of the mobile phone. Previous SIM card readers do not meet the target of saving restriction area and operational space.

### SUMMARY OF THE INVENTION

The present invention is a half length SIM card reader with a cover and a hinge. By using the half length SIM card reader, the restriction area on the printed circuit board is very small. The restriction area is about half the size of a SIM card, unlike other SIM card readers which require space longer than the SIM card. By having a small footprint, additional components are able to be included on the printed circuit board. Furthermore, the assembled cover with the hinge provides vertical operation of the SIM card.

### BRIEF DESCRIPTION OF THE DRAWINGS

FIG. 1 illustrates a side isometric view of the preferred embodiment of the present invention with an open cover.

FIG. 2 illustrates a side isometric view of the preferred embodiment of the present invention with a closed cover.

FIG. 3 illustrates a back isometric view of the preferred embodiment of the present invention with an open cover.

FIG. 4 illustrates a side isometric view of a comparison of the preferred embodiment of the present invention with prior SIM card readers.

FIG. 5 illustrates a side isometric view of a mobile phone implementing the preferred embodiment of the present invention.

FIG. 6 illustrates a flowchart of a process of manufacturing a half length SIM card reader with a cover and a hinge on a printed circuit board.

### DETAILED DESCRIPTION OF THE PREFERRED EMBODIMENT

A Subscriber Identity Module (SIM) card reader with a half length cover and a hinge allows an area on a printed circuit board below a received SIM card to be used for additional components or test points. By having a small footprint, roughly half the size of a full length SIM card reader, the present invention enables the production of smaller mobile phones. In addition to having a small footprint, the present invention also requires a small operational space.

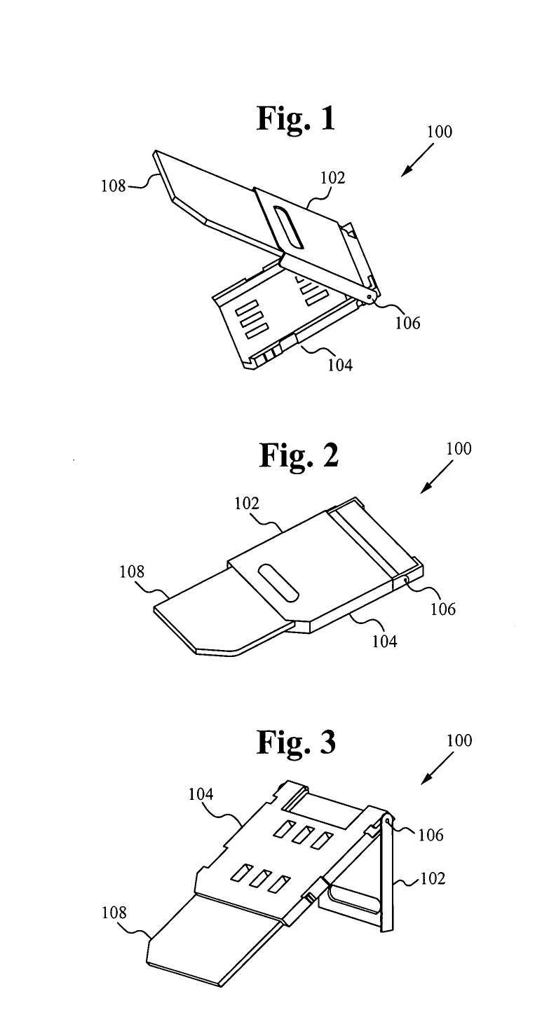

FIG. 1 illustrates a side isometric view of the preferred embodiment of the present invention with an open cover. A SIM card reader includes a cover 100 with a first side 102 and a second side 104 in addition to a hinge 106. The width of the cover 100 is sized for receiving a SIM card 108. The length of the cover 100 is sized so that only roughly half of the SIM card 108 is covered by the cover 100. Therefore, when the cover 100 is coupled to a printed circuit board 502 (FIG. 5), there is an open area on the printed circuit board 502 (FIG. 5) for small components to be placed where the cover 100 is not located. The hinge 106 allows the cover 100 to open and close for receiving the SIM card 108. The SIM card reader also contains the necessary components to enable reading information stored on the SIM card 108.

Preferably, one side of the SIM card reader is mechanically and electrically coupled to a printed circuit board. One side of the SIM card reader includes interior electrical contacts for operatively coupling to a SIM card in the usual manner. By inserting the SIM card 108 into the SIM card reader, the SIM card 108 becomes operatively coupled to the printed circuit board.

FIG. 2 illustrates a side isometric view of the preferred embodiment of the present invention with a closed cover. As described, the SIM card reader includes a first side 102 and a second side 104 (FIG. 1) which are coupled together by a hinge 106 which allows the cover 100 to open and close. After the SIM card 108 is inserted within the cover 100, the cover 100 is closed to retain the SIM card 108. When closed, the cover 100 holds the SIM card 108 in an operative relationship to the printed circuit board.

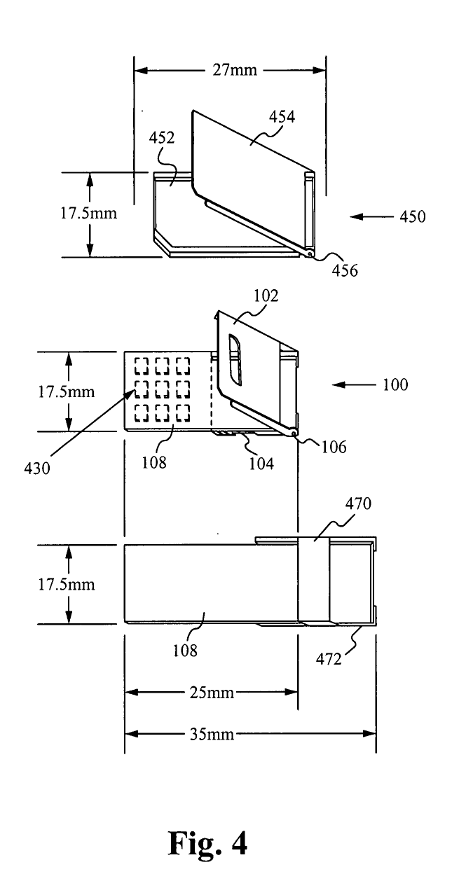

FIG. 3 illustrates a back isometric view of the preferred embodiment of the present invention with an open cover.

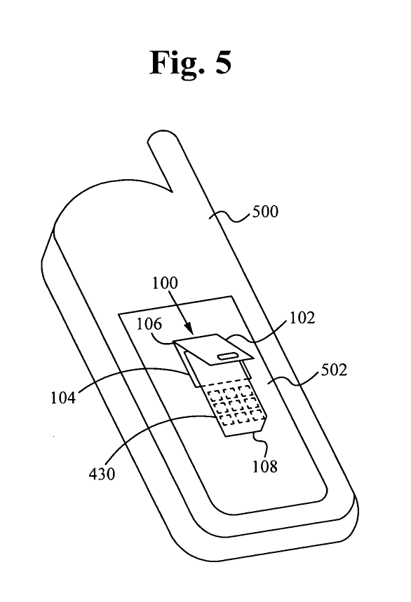

FIG. 4 illustrates a side isometric view of a comparison of the preferred embodiment of the present invention with prior SIM card readers. A full length SIM card reader with a full length cover 450 has a first side 452 and a second side 454, where both sides are a full length of a SIM card. The first side 452 and the second side 454 of the full length SIM card reader are coupled together by a hinge for opening and closing the cover 450. A bridged half length SIM card reader includes a bridge 470 and a half length backing 472. As described above, the present invention includes a cover 100 which has two half length sides: a first side 102 and a second side 104, which are coupled together by a hinge 106.

As is shown, the overall size of the present invention is much smaller than that of a conventional length SIM card reader. The footprint of a full length SIM card reader is 27 mm×17.5 mm whereas the footprint of the present invention is roughly 13.5 mm×17.5 mm. The cover 100 of the present invention itself is clearly smaller, but even with the inserted SIM card 108, the overall length of the present invention is 25 mm versus 27 mm for the full length SIM card reader. The area of a printed circuit board 502 (FIG. 5) underneath where the SIM card extends beyond the cover 100 of the present invention is able to support additional components 430 for other purposes.

The bridged half length SIM card reader itself is relatively small, but when the SIM card 108 is inserted, the combined size (e.g. the operational space) is significantly larger than the present invention with an inserted SIM card. The operation space length of the present invention is only 25 mm, roughly the length of a SIM card, whereas the operation space length of the bridged half length SIM card reader is 35 mm.

FIG. 5 illustrates a side isometric view of a mobile phone implementing the preferred embodiment of the present invention. Preferably, a half length SIM card reader with a cover 100 with a first side 102 and a second side 104 coupled together by a hinge 106 are contained within a mobile phone 500. The cover 100 is coupled to a printed circuit board 502 within the mobile phone 500. Since the cover 100 of the half length SIM card reader has a footprint of roughly half of the length of a SIM card 108, the printed circuit board 502 is able to utilize the space underneath the SIM card 108 for additional components 430.

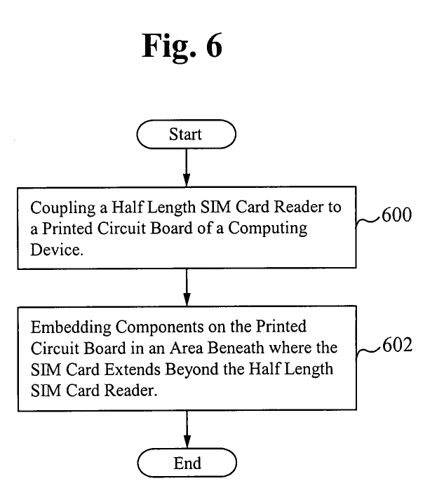

FIG. 6 illustrates a flowchart of a process of manufacturing a half length SIM card reader with a cover and a hinge on a printed circuit board. In the step 600, the half length SIM card reader is coupled to the printed circuit board of a computing device such as a mobile phone. Only one side of the cover of the half length SIM card reader is coupled to the printed circuit board so that the other side is able to open to receive the SIM card. In the step 602, components are embedded on the printed circuit board in the area beneath where a received SIM card would extend beyond the half length SIM card reader. The components are sized small enough so that a SIM card is able to still be received in the SIM card reader. The order of placing the SIM card reader and the additional components is able to be reversed such that the components are placed first and then the SIM card reader.

To utilize the present invention, a side of the cover is coupled to a mobile phone or other computing device. The side not coupled to the computing device is opened to receive a SIM card. Once the SIM card is inserted into the SIM card reader, the SIM card is secured in place by closing the opened side. With a secured SIM card, the SIM card reader is able to read tile information stored on the SIM card and transfer the information to the computing device. The computing device then uses the information as desired.

Furthermore, when manufacturing a computing device such as a mobile phone with the present invention, an area on a printed circuit board is designated to receive the half length cover of the SIM card reader which is roughly half the length of a SIM card. Additional components that are small enough to fit beneath a received SIM card are installed on the printed circuit board in the area that will be covered by the received SIM card.

In operation, the present invention is implemented within or on a computing device such as a mobile phone. Users are able to easily insert and remove a SIM card into the cover of the SIM card reader by opening the side of the cover so that the SIM card fits within the cover. While inserted into the SIM card reader, the SIM card is able to be read from or written to. Since the SIM card reader is roughly half the length of the SIM card, a significant amount of space on the printed circuit board is still available, unlike with a full length SIM card reader. With the available space on the printed circuit board, additional components are able to be embedded in the phone, thus enabling a smaller phone.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

1. An apparatus for receiving a Subscriber Identity Module (SIM) card comprising:
a. a first side;
b. a hinge coupled to the first side; and
c. a second side rotatably coupled to the first side by the hinge and including means for mechanically and electrically coupling to an electronic system such that the first side and the second side have an open position to receive the SIM card and a closed position wherein the SIM card is operatively coupled to the system, further wherein the first side and the second side are smaller than the SIM card, and further wherein approximately half of the SIM card extends beyond the second side.

2. The apparatus as claimed in claim 1 wherein the first side and the second side have a width of approximately 17.5 mm and a length of approximately 13.5 mm.

3. The apparatus as claimed in claim 1 wherein the second side is coupled to a printed circuit board.

4. The apparatus as claimed in claim 3 wherein the printed circuit board is within a mobile phone.

5. The apparatus as claimed in claim 3 wherein one or more additional components are contained on the circuit board beneath where the SIM card extends out beyond the second side.

6. (canceled)

7. The apparatus as claimed in claim 1 wherein an operational size of the apparatus with a received SIM card is a length approximately equal to a length of the SIM card.

8. A mobile phone comprising:
a. a circuit board within the mobile phone; and
b. a Subscriber Identity Module (SIM) card reader with a cover coupled to the circuit board for receiving a SIM card, wherein the cover comprises:
i. a first side;
ii. a hinge coupled to the first side; and
iii. a second side rotatably coupled to the first side by the hinge and including means for mechanically and electrically coupling to an electronic system such that the first side and the second side have an open position to receive the SIM card and a closed position wherein the SIM card is operatively coupled to the system, further wherein the first side and the second side are smaller than the SIM card and further wherein approximately half of the SIM card extends beyond the SIM card reader.

9. The mobile phone as claimed in claim 8 wherein the first side and the second side of the cover have a width of approximately 17.5 mm and a length of approximately 13.5 mm.

10. The mobile phone as claimed in claim 8 wherein one or more additional components are contained on the circuit board beneath where the SIM card extends out from the SIM card reader.

11. The mobile phone as claimed in claim 8 wherein an operational size of the SIM card reader with a received SIM card is a length approximately equal to a length of the SIM card.

12. (canceled)

13. A method of manufacturing a computing device with a Subscriber Identity Module (SIM) card reader comprising:
a. coupling the SIM card reader to a printed circuit board of the computing device; and
b. embedding one or more components on the printed circuit board in an area beneath where a SIM card extends beyond the SIM card reader, wherein approximately half of the SIM card extends beyond the SIM card reader.

14. (canceled)

15. The method as claimed in claim 13 wherein the SIM card reader comprises a cover comprising:
a. a first side;
b. a hinge coupled to the first side; and
c. a second side rotatably coupled to the first side by the hinge and including means for mechanically and electrically coupling to an electronic system such that the first side and the second side have an open position to receive the SIM card and a closed position wherein the SIM card is operatively coupled to the system, further wherein the first side and the second side are smaller than the SIM card.

16. The method as claimed in claim 15 wherein the first side and the second side have a width of approximately 17.5 mm and a length of approximately 13.5 mm.

17. The method as claimed in claim 13 wherein the computing device is a mobile phone.

18. The method as claimed in claim 13 wherein an operational size of the SIM card reader with a received SIM card is a length approximately equal to a length of the SIM card.
